(19) United States
(12) Patent Application Publication
(10) Pub. No.: US 2010/0006119 A1
(43) Pub. Date: Jan. 14, 2010

(54) Floss Box for Public Places

(75) Inventors: Marcel Branco Veras, Curitiba (BR); João Alpheu Queiroz Braga, Curitiba (BR); Neslon Gasparotto, Curitiba (BR)

Correspondence Address: BACON & THOMAS, PLLC, 625 SLATERS LANE, FOURTH FLOOR, ALEXANDRIA, VA, 22314-1176, US

(73) Assignee: MARCEL BRANCO VERAS, Curitiba (BR)

(21) Appl. No.: 11/794,535

(22) PCT Filed: Dec. 30, 2005
(86) PCT No.: PCT/BR05/00263

§ 371 Date: Jan. 28, 2008

(30) Foreign Application Priority Data
Jan. 4, 2005 (BR) P10500051-3
Dec. 27, 2005 (BR) C10500051-3

(51) Int. Cl. A61C 15/04

(52) U.S. Cl. 132/325; 132/323

(57) ABSTRACT

Improvement in floss box for public place, wherein the box comprises a general structure (1) that is defined by a base (2) to be mounted against the wall, and a cover (3) defined in a way to recover all internal devices of the box; the base (2) incorporates a mounting support (4), wherein it is positioned a bobbin (5); the base (2) receives the mounting of the direction pulley (6), which is fixed along with an axis (7) centered on the base (2), said pulley having a small channel (8), wherein the floss box hereby treated characterized by the fact that in the bottom of the channel (8) of direction pulley (6) is provided a perimeter cavity (9); the referred perimeter cavity (9) retains floss (X) along with periphery of direction pulley (6), making the said floss (X) to assume a more favorable condition at the moment of its exposure due to the expelling device (10) action. The improved box hereby treated counts on an activation lever (13), which operates an activation device (14) of direction pulley (6); activation device (14) of direction pulley (6) comprises a lock (15) that spins around a pivot (16), wherein the referred lock (15) comprises a blade (17) that operates against the action of a spring (18), said blade (17) is moved, in a specific moment by a pin (19) that is mounted in the back face of the direction pulley (6)

The present patent of Invention Privilege refers to improvement in floss box, the kind that is to be located in public places, such as toilets in restaurants, airports, railway stations, and bus stations, or any other place with great public circulation.

The current State of Art comprises some floss dispenser devices, such as the one mentioned at MU 8000025-8 from 12 Jan. 2000 and that refers to a “DISPOSAL AND CONSTRUCTIVITY IN FLOSS BOX FOR USERS IN PUBLIC PLACES”, or the one mentioned at MU 8100772-8 from 18 Apr. 2001 whose title is “IMPROVEMENT IN FLOSS BOXES FOR PUBLIC PLACES”, being both patent application developed and deposited by applicants of present application of patent and Invention Privilege.

Specially regarding to MU 8100772-8 it is described a floss box for public places where it is contemplated a fixation base 2 generally rectangular designed, a slab fixed on the wall in a vertical and parallel way through any mean of fixation (Velcro, glue, adhesive tape); a cover 3 in a general parallelepiped format with rounded borders, and scooped by its back face that fits by the ends of this on the fixation base 2, having a small hole 3a vertically on its bottom face; a floss A bobbin 4 fitted in two side supports 4A symmetrically fixed on base 2, near its top and side ends; a direction pulley 5 with general format similar to a wheel, perpendicularly by its central part on a vertical axis 5A on base 2, and having a small channel 5B caved around the circle, and a small cutting 5C of a general format of a “V” from the end until near the center: an activation lever on a horizontal axis 6A fixed on base 2 near left side of it, putting the activation lever 6 between bobbin 4 and direction pulley 5 from internal part of the box 1 until external part, and having a little support of activation 6B of a format slightly curved on external end; a limiting and returning spring 7 of activation lever 6 is fixed by one of its ends on base 2, between one of the side supports 4A and the side of base 2, and on the other end, in a little hole 6C of the activation lever 6; one unlocking lever 8 of the direction pulley 5 of a general parallelepiped format fixed by gluing under the direction pulley end 5, near activation lever 6, having a small cutting 8A of a general format in “L” in the end of the direction pulley 5; a component of transmission 9 between activation lever 6 and unlocking lever 8 from activation lever 6, in a general rectangular format, perpendicularly fixed between these through small fixation pins 9A; a locking pin 10 from direction pulley 5 fixed under it and along with the end of direction pulley 5 unlocking lever in a way that it stays perfectly fitted in the small cutting 8A; a fixation and cut component 11 from floss A in a general rectangular format fitted in the small channel 5B of the direction pulley 5 circle; a support component 12 of running through the floss A in a general rectangular format fixed on base 2, with two small holes, a bigger 12A and a smaller 12B near an end disposed free from direction pulley 5; a locking spring 13 in a rectilinear format with a up bending from half of its length, fixed by one of its ends on base 2 by the other along with locking pin 10, under direction pulley 5 in a way to keep aligned with unlocking lever 8; an output channel 14 from floss A fixed centered in a perpendicular way on the base 2 end, along with bottom face floss A of box 1, from small channel 513 of direction pulley 5 to small hole 3A, linking both, along a upholder support 14A in a general rectangular format vertically fixed on base 2; an upholder support 15 of a rectangular format fixed on base 2 in a parallel way to its bottom side and in a perpendicular to support 14A; a clasp of displacement 16 of floss A of a specific format with folding in “L” in a way to be fitted along with upholder supports 14A and 15; and a connection part 17 in a general cylindrical format, on small diameter, fixed parallel to base 2 and under direction pulley 5, from join of unlocking lever 8 with transmission part 9 to upholder support 15.

The box above mentioned although representing a remarkable advance referred to prior model (MU 8000025-8) still presents some aspects to be improved, such as: floss accommodation around direction pulley; expelling means of the end of the referred floss after activation lever operation; device that mechanically links activation lever to direction pulley; and general configuration of the bottom opening provided on the cover.

According to the above mentioned it was developed the box object of this patent of Invention Privilege which will be detailed described with reference to the draws below related wherein:

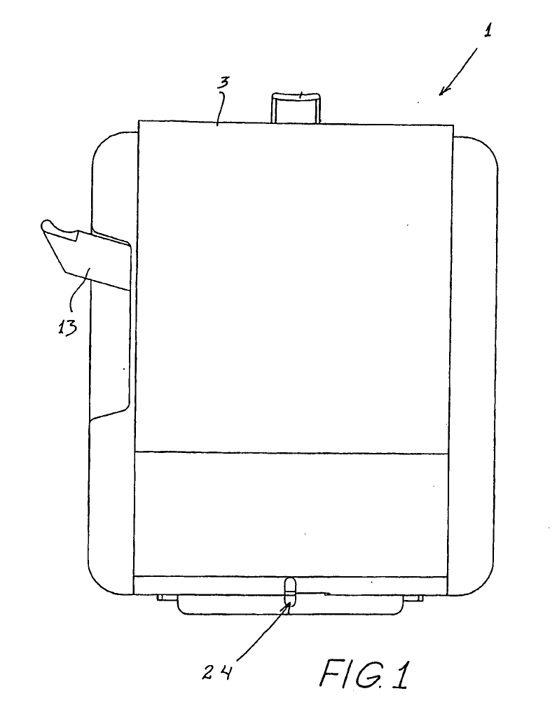

FIG. 1 illustrates a general view of the box in question;

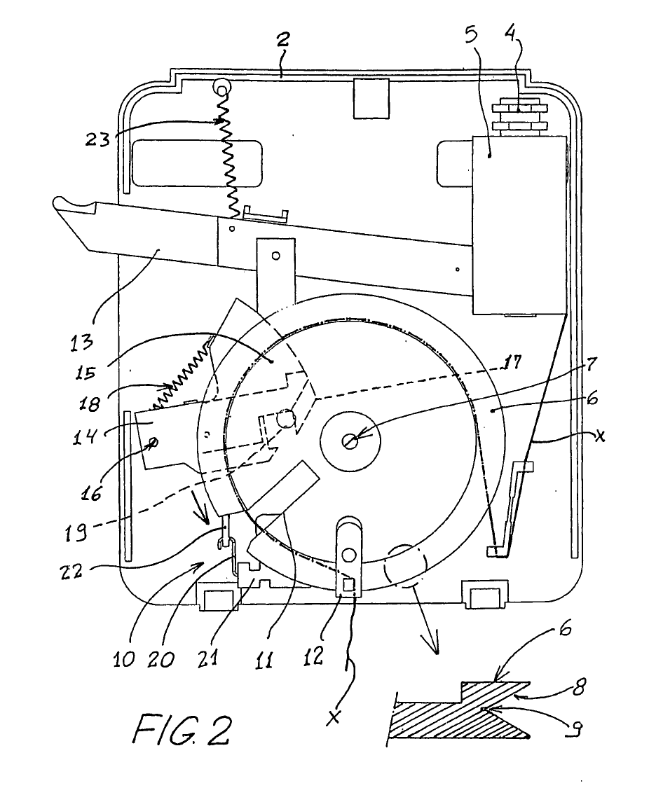

FIG. 2 illustrates a schematic and open general view of the box hereby treated, being it in its initial position before activation, such FIG. 2 includes a wide and in cut detail that is taken from direction pulley of the present box;

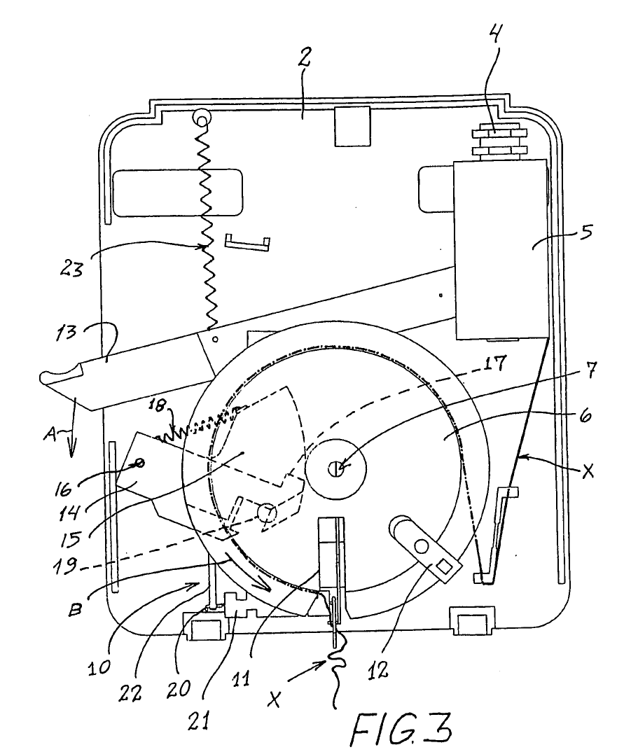

FIG. 3 illustrates a similar view to the reported in previous figure, but showing box activation hereby treated;

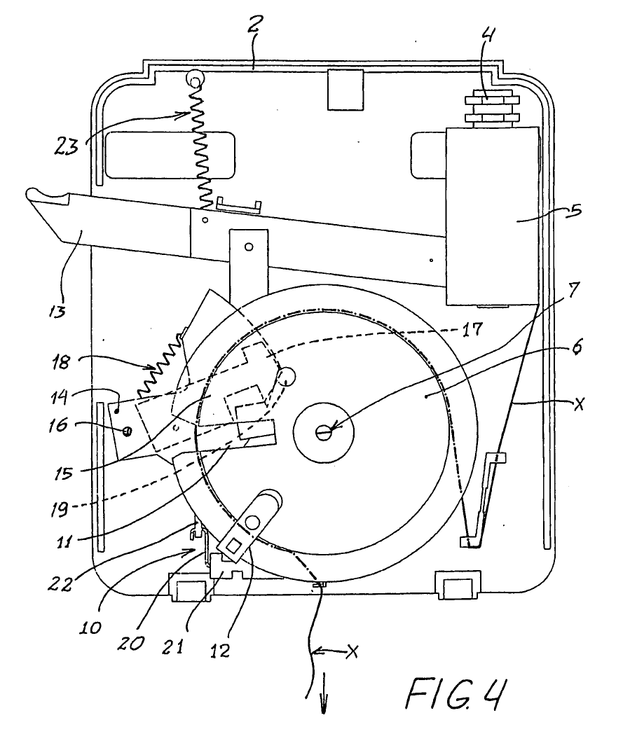

FIG. 4 illustrates the box in question at the moment in which a piece of floss is being pulled;

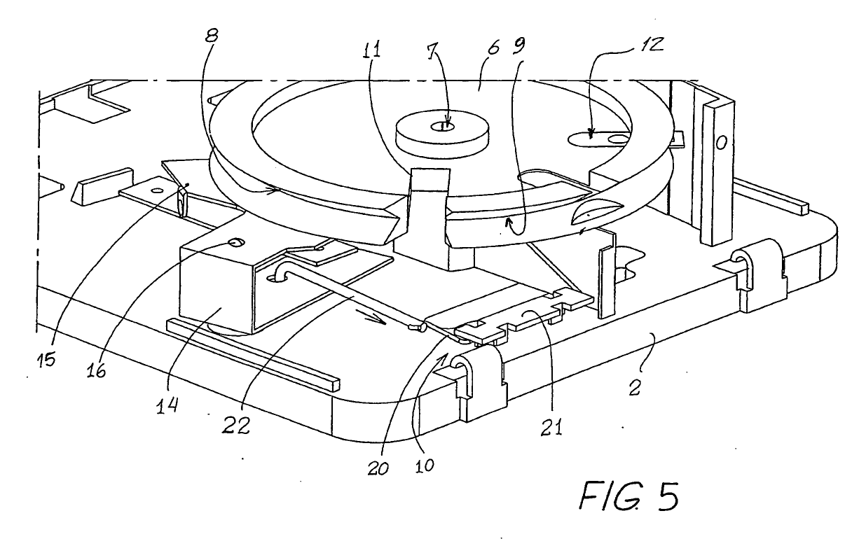

FIG. 5 illustrates a partial view similar and in perspective of internal device of the box here treated being it in its initial stage before its activation;

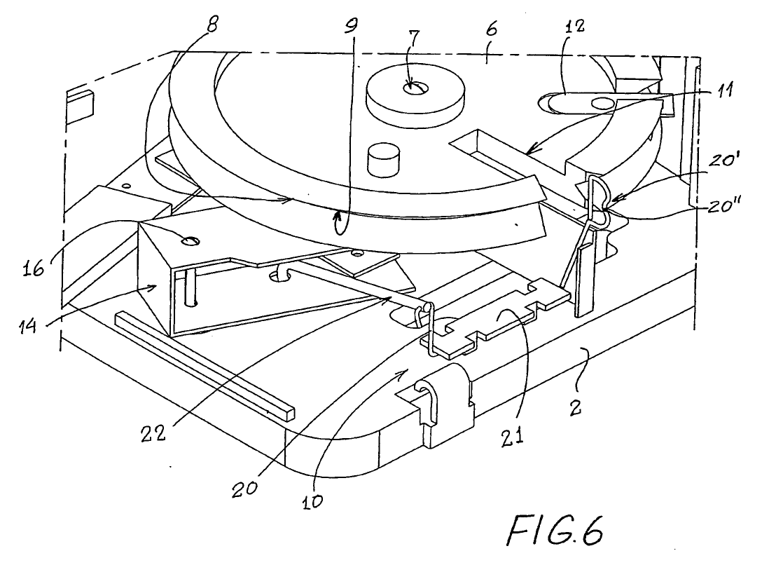

FIG. 6 illustrates a view similar to the one mentioned in the previous figure where it is showed device activation that exposes floss to consumer; and

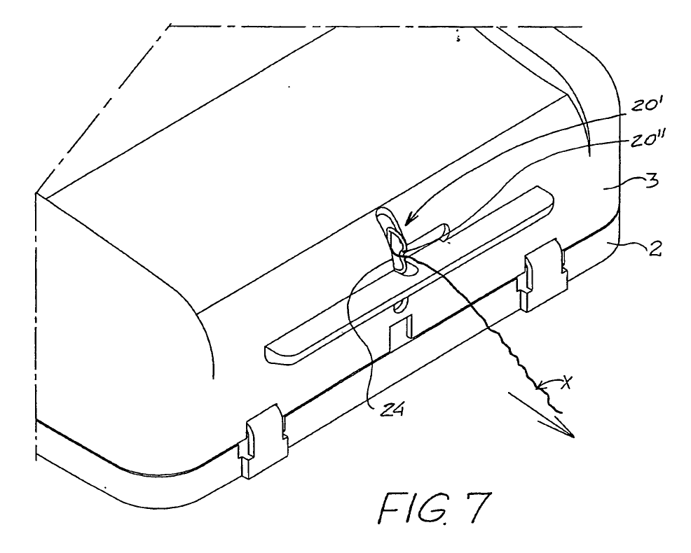

FIG. 7 illustrates a schematic detailed and in perspective of the bottom of the box at the moment of the floss exposition

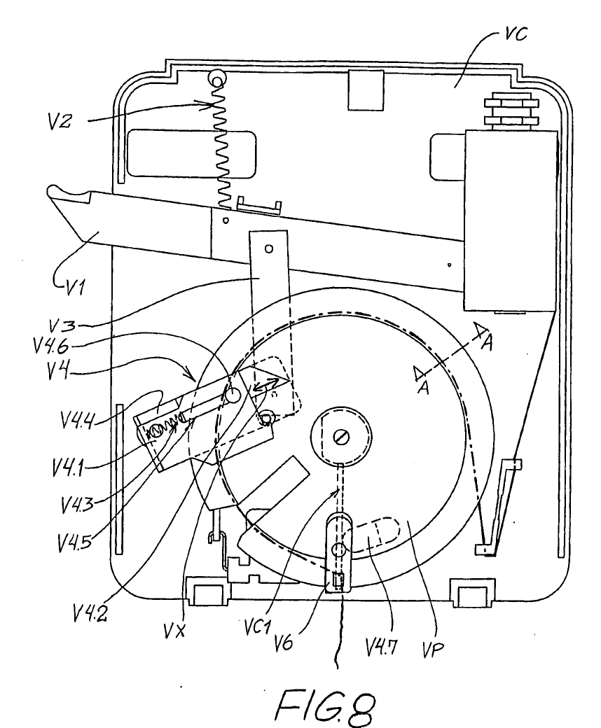

FIG. 8 illustrates a general schematic and open view of a variation of the floss box herein presented, being it in its initial stage, before its activation;

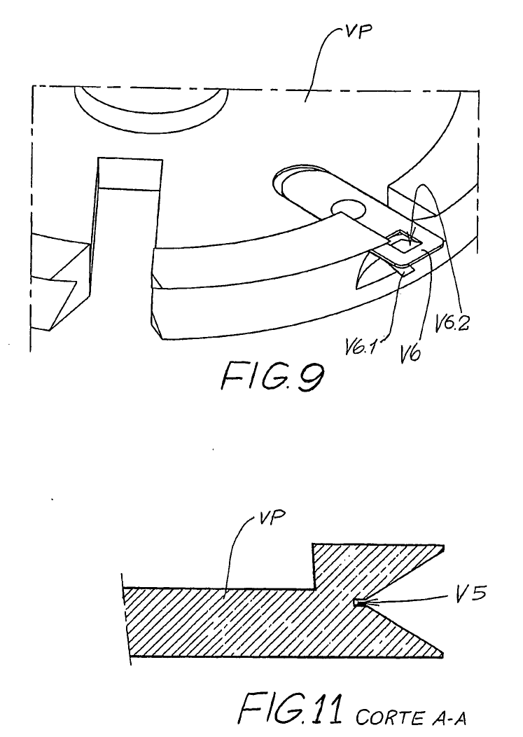

FIG. 9 illustrates a schematic detail of the variation of FIG. 8 where it depicted the cutting device that is fixed in the pulley;

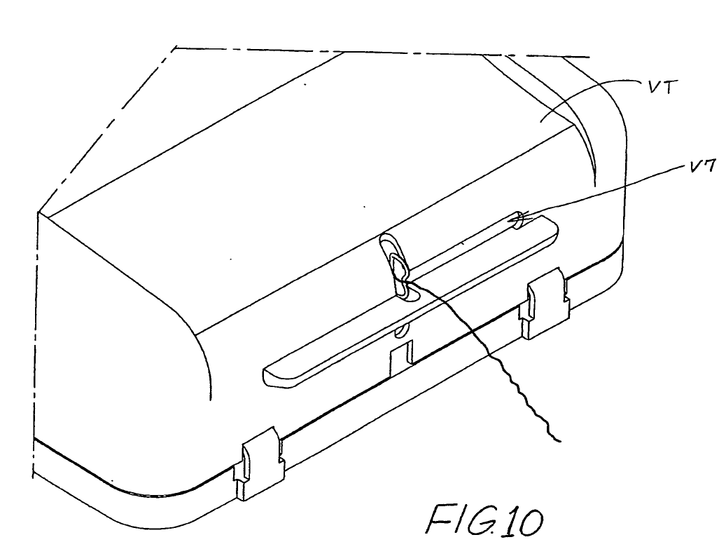

FIG. 10 illustrates a schematic detailed and in perspective of the bottom of the variation of the box depicted in FIGS. 8 and 9, in a moment in which the floss is being expelled; and

FIG. 11 illustrates a cutting A-A from FIG. 8.

According to how much the figures above mentioned illustrate, the improvement in floss box for public places object of this patent of Invention Privilege comprises a general structure 1 that is defined by a base 2 to be mounted against the wall, and a cover 3 defined in a way to recover all box internal devices.

Base 2 incorporates a support of mounting 4 where it is placed a bobbin 5, which can present movement of spinning, or alternatively cannot present rolling movement, since its vertical positioning allows floss X to be naturally unrolled as it is tracked down.

Base 2 receives montage of a direction pulley 6 which is fixed together with an axis 7 centered over base 2, said pulley having small channel 8 (visible specifically in details in cutting that integrates FIG. 2) in the bottom of which, differently of what was shown in state of art; it is contemplated a perimeter cavity 9, in order to serve as a place for natural housing and related to imprisonment of floss X when it is in touch with direction pulley 6.

Referred perimeter cavity 9 retains floss X along with periphery of direction pulley 6 making the said floss X to assume a more favorable condition at the moment of its exposition due to expelling device 10 action.

Direction pulley 6, according to what was shown in the state of art, presents a cutting 11 analogue to cut SC present in the box belonging to patent request MU 8100772-8, the same for cut device 12 that executes in an automatic way the cut of floss X at the appropriate moment.

Improved box hereby treated counts on a activation lever 13 similar to activation lever 6 contemplated in the before mentioned, being now, in the present case, activation lever 13 operates an activation device 14 of direction pulley 6 totally diverse from what was shown in state of art.

In the present invention, activation device 14 of direction pulley 6 comprises a lock 15 that spins around a pivot 16, being that the referred lock 15 comprises a blade 17 that operates against an action of a spring 18, said blade 17 is moved, in a given moment by a pin 19 that is mounted in the back face of direction pulley 6. The function of lock 15 is to stop direction pulley 6, which spins normally in anticlockwise, from spinning in the opposite way for any reason.

By systematic of function of present box, activation pulley rotation 6 sets that in a specific moment, its pin 19 gets in touch with blade 17, which has a cavity that stops pin 19, after reaching a specific point, from returning due to activation pulley spin in an inverse way from the normal.

By reaching ideal point, direction pulley 6 only can be spinned by the action of the activation lever 13 that works against the action of a spring 23.

The spin of direction pulley 6 due to lowering of lever 13 makes expelling device 10 to be also activated.

Expelling device 10 can be better appreciated in the FIGS. 5 and 6, and it is formed by a folded metallic pole 20 that is mounted in a support 21, being connected to an arm 22 that is connected to the lock 15.

When lever 13 is lowered, it moves lever 15 also down, which also displace down arm 22 that is connected to one of the ends of the pole 20, and such movement making the opposed end of pole 20, which is responsible by expelling the floss X, to be compressed against direction pulley 6 back face. The end of the pole 20 that contacts with floss X and that is indicated by reference 20′, such as specifically indicated in FIGS. 6 and 7, presents a similar or analogue configuration to a letter “B”, wherein the central region of the reentrance of “B”, indicated as “20”, is dimensioned and positioned in order to orient floss X expelling.

The effect of compression imposed to pole 20 occurs up to the moment that direction pulley 6 spins the enough so that the referred pole 20 reaches the cut 11 of it, moment that occurs an abrupt liberation movement of pole 20 that removes the end of floss X that is placed in the perimeter cavity 9 of direction pulley 6.

The abrupt movement of liberation of pole 20, besides removing the end of floss X from its place in the perimeter cavity, makes such end of floss X to be expelled out of the opening 24 contemplated in the bottom face of the cover 3 and that is visible only in FIGS. 1 and 7.

FIGS. 8, 9, 10 and 11 depict a variation of the said box, wherein its several parts are indicated by references preceded by letter V. The variation from FIGS. 8, 9, 10 and 11 comprises an activation device that is formed by an activation lever V1, by spring V2 from activation lever V1, by transmission arm V3 and by lock device V4.

The device from the others locks comprises a blade support V4.1, the mobile blade V.4.2 and spring V.4.3. Blade support V.4.1 is fixed on VC body of the box through a pivot axle V4.4.

It is also important to point that the blade support V4.1 has a cut V4.5 that functions as a rail for blade V4.2 on its portion which is on the surface of pulley VP, such blade in order to use the cut as a rail has in its body a pine V4.6.

As it happens with the main model indicated in FIGS. 1 to 7, in the variation from FIGS. 8, 9, 10 and 11, the operation of the present box occurs by means of activation lever V1 that is pushed down being such movement transmitted for lock device V4 through transmission arm V3.

In a given situation, blade V4.2 pushes pine VP1 down from pulley, which ends up for making the pulley to spin. As floss is pulled, pulley VP continues spinning and pine VPl ends up executing a complete round returning to its point in which it is pushed down, but before arriving to this point pine VP1 makes blade V4.2 to move through the cut V4.5 and such blade V4.2 movement is represented by arrow X in FIG. 8. Said blade V4.2 movement only occurs when pulley is being counterclockwise moved.

Being also part of activation device, it is located in pulley VP bottom face a metallic lock V4.7, such lock functions to prevent pulley from spinning clockwise, and to do so, metallic lock V4.7 ends up touching a VC1 wall that belong to body VC of the box when pulley VP is perhaps moved clockwise.

Another alternative designed and presented in the floss box for public places according to variation in FIGS. 8, 9, 10 and 11 regards to enlargement of perimeter cavity existent in pulley VP. In the model indicated in the FIGS. 1 to 7 such perimeter cavity that is referenced by indication 9, has floss exact width, however, perimeter cavity, contemplated in the variation indicated in FIGS. 8, 9, 10 and 11 referenced by indication V5, belonging to pulley VP of the box herein mentioned it is necessarily wider than floss, that is, floss is not so narrowly stuck as it occurs in the main model mentioned in FIGS. 1 to 7.

Another difference contemplated in the variation indicated in FIGS. 8, 9, 10 and 11, regards to a new configuration presented in the cut device, hereinafter referenced as V6.

The cut device referenced as 12 in the box model indicated in FIGS. 1 to 7 aims to execute the cut in floss in an automatic manner and presents an alternative setting regarding to the existence of a longitudinal tail V6.1 inserted under cutting device itself that is better indicated through FIG. 9. Such tail V6.1 aims to set that the floss always enters in the cutting hole V6.2, and it permits a larger facility during floss bobbin change, inasmuch, with such alternative, executor of floss bobbin change does not need to manually put the floss edge inside the said hole V6.2, once the tail V6.1 makes this function in an automatic manner.

Last difference indicated in variation of FIGS. 8, 9, 10 and 11 regards to increase of the opening of the cover bottom, such opening that is referenced as 24 in the main model indicated in FIGS. 1 to 7. Note that it is by such opening the floss is expelled out of the box. For the variation described in FIGS. 8, 9, 10 and 11, the Holder designed a cover T with an opening referenced as V7 larger, more specifically, the opening V7 presented in the bottom of the cover VP has at least the size of the floss to be expelled. Thus, floss edge does not remain inside the box because it does not find any obstacle during its expelling.

1. “IMPROVEMENT IN FLOSS BOX FOR PUBLIC PLACES”, wherein the box comprises a general structure (1) that is defined by a base (2) to be mounted against the wall, and a cover (3) defined in a way to recover all internal devices of the box; the base (2) incorporates a mounting support (4), wherein it is positioned a bobbin (5); the base (2) receives the mounting of the direction pulley (6), which is fixed along with an axis (7) centered on the base (2), said pulley having a small channel (8), wherein the floss box hereby treated characterized by the fact that in the bottom of the channel (8) of direction pulley (6) is provided a perimeter cavity (9); the referred perimeter cavity (9) retains floss (X) along with periphery of direction pulley (6), making the said floss (X) to assume a more favorable condition at the moment of its exposure due to the expelling device (10) action. The improved box hereby treated counts on an activation lever (13), which operates an activation device (14) of direction pulley (6); activation device (14) of direction pulley (6) comprises a lock (15) that spins around a pivot (16), wherein the referred lock (15) comprises a blade (17) that operates against the action of a spring (18), said blade (17) is moved, in a specific moment by a pin (19) that is mounted in the back face of the direction pulley (6); the present box also comprises an expelling device (10) that is formed by a mechanical folded pole (20) that is mounted in a support (21), being connected in an arm (22) that is connected to the lock (15).

2. “IMPROVEMENT IN FLOSS BOX FOR PUBLIC PLACES”, according to what is claimed in 1, characterized by the fact that the bobbin (5) presents spinning movement.

3. “IMPROVEMENT IN FLOSS BOX FOR PUBLIC PLACES” according to what is claimed in 1, characterized by the fact that the bobbin (5) does not present spinning movement.

4. “IMPROVEMENT IN FLOSS BOX FOR PUBLIC PLACES” according to what is claimed in 1, characterized by the fact that the perimeter cavity (9) contemplated in the bottom of the channel (8) of direction pulley (6) is to serve as a place for natural housing and the related imprisonment of floss (X) when it is in touch with direction pulley (6).

5. “IMPROVEMENT IN FLOSS BOX FOR PUBLIC PLACES” according to what is claimed in 1, characterized by the fact that the lock (15) function is to stop direction pulley (6), which normally spins clockwise, from spinning anticlockwise for any reason.

6. “IMPROVEMENT IN FLOSS BOX FOR PUBLIC PLACES” according to what is claimed in 1, characterized by the fact that when lever (13) is lowered, it moves lever (15) also down, which also displace down arm (22) that is connected to one of the ends of the pole (20), and such movement making the opposed end of pole (20) that is responsible for expelling the floss (X) to be compressed against direction pulley (6) back face.

7. “IMPROVEMENT IN FLOSS BOX FOR PUBLIC PLACES” according to what is claimed in 1 and 6, characterized by the fact that he end of the pole (20) that contacts with floss (X) and that is indicated by reference (20′), presents a similar or analogue configuration to a letter “B”, wherein the central region of the reentrance of “B”, indicated as “20”, is dimensioned and positioned in order to orient floss X expelling.

8. “IMPROVEMENT IN FLOSS BOX FOR PUBLIC PLACES” characterized by the fact of contemplating a constructive variation that contemplates the activation device that is formed by and activation lever (V1), by spring (V2) from activation bar (V1), by transmission arm (V3) and by lock device (V4); the lock device comprises a blade support (V4.1) mobile blade (V4.2) and spring (V4.3); blade support (V4.1) it is fixed in the body (VC) of the box through and pivotant axle (V4.4); blade support (V4.1) has on 5) that functions as a rail for blade (V4. 2), such blade in order to use the cut (V4.5) as a rail has in its body a pine (V4.6); floss box for public places also comprises a metallic lock (4.7) located in the bottom face of the pulley (VP); the variation also contemplates a perimeter cavity (V9) of pulley (VP) necessarily wider that the floss; the variation also contemplates a cutting device (V6) different, wherein the said cutting device (V6) presents a setting that comprises the existence of a longitudinal tail (V6.1) inserted under cutting device (V6) itself; the variation also contemplates enlargement of the opening (V7) of the bottom of the cover (VT), having such opening (V7) at least the size of the edge of the floss to be expelled.

9. “IMPROVEMENT IN FLOSS BOX FOR PUBLIC PLACES”, according to what is claimed in 8, characterized by the fact that the metallic lock (V4.7) aims to prevent pulley (VP) from spinning clockwise for any reason; metallic lock (V4.7) ends up touching a wall (VC1) that belongs to body (VC) of the box when pulley (VP) is perhaps moved clockwise.

10. “IMPROVEMENT IN FLOSS BOX FOR PUBLIC PLACES”, according to what is claimed in 8, characterized by the fact that perimeter cavity (V5) presented in pulley (VP) is necessarily wider that makes that floss is not so narrowly stuck.

11. “IMPROVEMENT IN FLOSS BOX FOR PUBLIC PLACES”, according to what is claimed in 8, characterized by the fact that a longitudinal tail (V6.1) inserted under cutting device (V6) aims to set that the floss always enters in the cutting hole (V6.2) in an automatic manner.

12. “IMPROVEMENT IN FLOSS BOX FOR PUBLIC PLACES”, according to what is claimed in 1, characterized by the fact that the opening (V7) present in the bottom of the cover (VT) that has at least the size of the floss to be expelled, ends up to enable the floss not to remain inside the box.
